(19) United States
(12) Patent Application Publication
(10) Pub. No.: US 2023/0008962 A1
(43) Pub. Date: Jan. 12, 2023

(54) ROTATION CONTROL MECHANISM FOR FOLDING LADDER, AND FOLDING LADDER

(71) Applicant: Jiangsu Zhou Jijie Intelligent Technology Co., Ltd, Suqian (CN)

(72) Inventors: Xuelin ZHU, Suqian (CN); Baisong YAO, Suqian (CN); Weiqiang LIU, Suqian (CN)

(73) Assignee: Jiangsu Zhou Jijie Intelligent Technology Co., Ltd, Suqian (CN)

(21) Appl. No.: 17/782,668

(22) PCT Filed: Nov. 16, 2020
(86) PCT No.: PCT/CN2020/128929

§ 371 Date: Jun. 6, 2022

(30) Foreign Application Priority Data
Dec. 5, 2019 (CN) 201922155509.4

(51) Int. Cl. E06C 7/50; E06C 1/383; E06C 1/32

(52) U.S. Cl. CPC E06C 7/50; E06C 1/383; E06C 1/32

(57) ABSTRACT

A rotation control mechanism comprises a first rotating member, a second rotating member, and a first locking pin. The first rotating member is provided with a pin hole. The second rotating member is provided with a locking hole. The first locking pin is inserted into the pin hole and the locking hole to lock the first rotating member and the second rotating member. The first locking pin and the first rotating member are circumferentially limited and movably arranged in an axial direction. A first elastic member is connected to the first locking pin and applies an action force to the first locking pin to be inserted into the locking hole. The second rotating member is provided with a trigger portion, and the first rotating member is provided with an elastic braking portion. The folding ladder comprises two ladders and two rotation control mechanisms.

### CROSS REFERENCE TO THE RELATED APPLICATIONS

This application is the national stage entry of International Application No. PCT/CN2020/128929, filed on Nov. 16, 2020, which is based upon and claims priority to Chinese Patent Application No. 201922155509.4, filed on Dec. 5, 2019, the entire contents of which are incorporated herein by reference.

### TECHNICAL FIELD

The invention relates to a ladder, in particular to a rotation control mechanism for a folding ladder, and a folding ladder.

### BACKGROUND

In order to expand the application range of ladders, folding ladders are designed. Ladders on two sides of the folding ladder can be unfolded to extend the climbing distance, and can also be folded to different angles to adapt to different small climbing distances or to facilitate transport and storage.

At a folding joint of the folding ladder, a button and a handle are generally disposed on two sides of two rotating portions, and a locking pin is fixed to the handle and penetrates through the two rotating portions to fix the two rotating portions. The locking pin can be pushed through the button to retreat from at least one rotating portion so as to allow the two rotating portions to rotate. After the two rotating portions rotate to a desired angle, the handle is pushed to enable the locking pin to penetrate through the two rotating portions again. When the handle is pushed, locking holes of the two rotating portions need to be aligned, which makes operation inconvenient; and most parts at the joint are metal parts that need to be pushed with a great force from the handle, which causes inconvenience to users in use.

### SUMMARY

The objective of the invention is to overcome the above defects of the prior art by providing a rotation control mechanism for a folding ladder, and a folding ladder, which are simple in structure. Two rotating portions of the rotation control mechanism for a folding ladder can be locked automatically after being rotated to a required angle.

One technical solution adopted by the invention to fulfill the above objective is as follows: a rotation control mechanism for a folding ladder comprises a first rotating member, a second rotating member and a first locking pin, wherein the first rotating member is provided with a pin hole, the second rotating member is provided with a locking hole, and the first locking pin is inserted into the pin hole and the locking hole to lock the first rotating member and the second rotating member;

The first locking pin and the first rotating member are circumferentially limited and movably arranged in an axial direction;

A first elastic member is connected to the first locking pin and applies an action force to the first locking pin to be inserted into the locking hole;

The second rotating member is provided with a trigger portion;

The first rotating member is provided with an elastic braking portion;

An external force is applied to the first locking pin to retreat from the locking hole, the elastic braking portion abuts against the first rotating member, and the first rotating member and the second rotating member are allowed to rotate; when the first rotating member and the second rotating member rotate, the trigger portion pushes the elastic braking portion to retreat elastically, so that the elastic braking portion is no longer hindered by the first rotating member, and the first locking pin is aligned with the locking hole and is then inserted into the locking hole.

Wherein, the rotation control mechanism for a folding ladder further comprises an operating member and a center pin, wherein the first rotating member and the second rotating member are rotatably connected through the center pin; the operating member is fixed to the first locking pin after penetrating through the center pin, and the operating member is coaxial with the center pin; and the operating member pushes the first locking pin to move away from the locking hole.

Wherein, the first elastic member is a spring; the center pin is provided with a receiving cavity, and the operating member penetrates through the receiving cavity; and the spring is disposed around the operating member and is received in the receiving cavity.

Wherein, the elastic braking portion comprises a second elastic member and an engaging element, and the second elastic member abuts against the engaging element and is maintained in the first locking pin.

Wherein, the trigger portion is a plate, and the plate has an arc surface that abuts against with the elastic braking portion.

Wherein, the trigger portion is a protruding rib on the second rotating member, and the rib has an arc surface that abuts against the elastic braking portion.

Wherein, three locking holes are arranged, and three vacant sites where the elastic braking portion does not abut against the trigger portion are disposed at positions corresponding to the three locking holes.

Wherein, two arc surfaces are arranged, and the vacant sites are located between the two arc surfaces; and/or, the vacant sites are located at ends of the arc surfaces.

Wherein, the rotation control mechanism for a folding ladder further comprises a second locking pin, wherein the second locking pin and the first locking pin are distributed symmetrically with respect to a rotation axis of the first rotating member and the second rotating member; when the first locking pin enters the pin hole and the locking hole, the second locking pin is inserted into the first rotating member and the second rotating member; and when the first locking pin retreats from the locking hole, the second locking pin retreats from the second rotating member.

Wherein, the first rotating member comprises a first outer plate and a second outer plate, the second rotating member is disposed between the first outer plate and the second outer plate, and the first outer plate and the second outer plate are fixedly connected.

Wherein, a flange facing the second outer plate is formed on the first outer plate, and/or a flange facing the first outer plate is formed on the second outer plate; and the flange covers the second rotating member.

Wherein, a projection facing the first outer plate is formed on the second rotating member, and/or a projection facing the second outer plate is formed on the second rotating member.

Another technical solution adopted by the invention to fulfill the above objective is as follows: a folding ladder comprises two ladders, and two rotation control mechanisms for a folding ladder, wherein a top of one ladder is connected to the first rotating member, and a top end of the other ladder is connected to the second rotating member.

Wherein, each ladder comprises steps and two ladder legs, wherein two ends of each step are connected to the ladder legs, and the steps are hollow isosceles trapezoid profiles.

Wherein, two side faces of each step are concave-convex faces.

Wherein, three axial holes are formed in an inner surface of each step and are located in a middle of an inner side of a top and two corners of a bottom of the step respectively.

Wherein, the ladder further comprises gaskets, and screws penetrate through the gaskets, the ladder legs and the axial holes sequentially to connect the ladder legs and the steps.

According to the rotation control mechanism for a folding ladder, and the folding ladder of the invention, under the action of the trigger portion, the elastic braking portion and the first elastic member, the two rotating members of the rotation control mechanism for a folding ladder can be automatically rebounded and locked after being rotated to a required angle; and the rotation control mechanism and the folding ladder are simple in structure and convenient to use.

### BRIEF DESCRIPTION OF THE DRAWINGS

FIG. 1 is a structural view of a rotation control mechanism for a folding ladder according to the invention;

FIG. 2 is a sectional view of the rotation control mechanism for a folding ladder in a locked state according to the invention;

FIG. 3 is a sectional view of the rotation control mechanism for a folding ladder in an unlocked state according to the invention;

FIG. 4 is a connection diagram of a ladder leg and a step according to the invention;

1, first rotating member; 11, pin hole; 12, first outer plate; 13, second outer plate; 14, flange;

2, second rotating member; 21, locking hole; 22, projection;

31, trigger portion; 31a, vacant site; 32, engaging element; 33, second elastic member; 34, first elastic member;

41, center pin; 41a, receiving cavity; 42, operating member;

51, first locking pin; 52, second locking pin;

61, step; 61a, side face; 61b, axial hole; 62, ladder leg; 63, gasket; 64, screw.

### DETAILED DESCRIPTION OF THE EMBODIMENTS

The invention will be described in further detail below in conjunction with the accompanying drawings and embodiments. The following embodiments are used to explain to the invention, but the invention is not limited to the following embodiments.

### EMBODIMENT

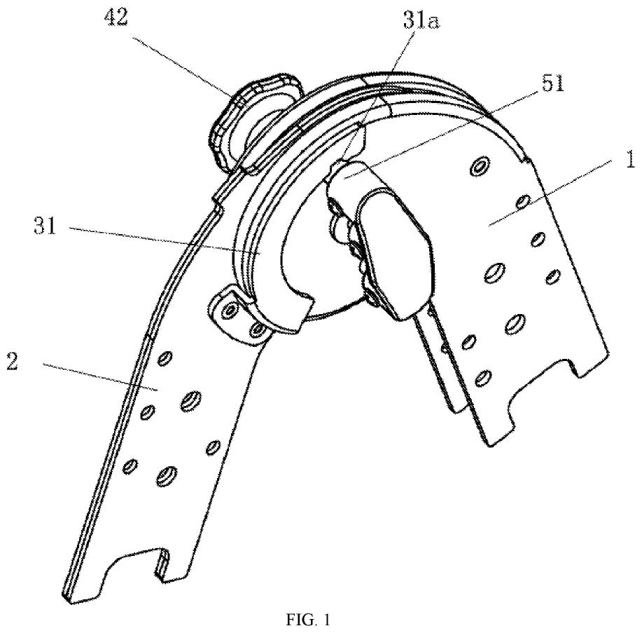

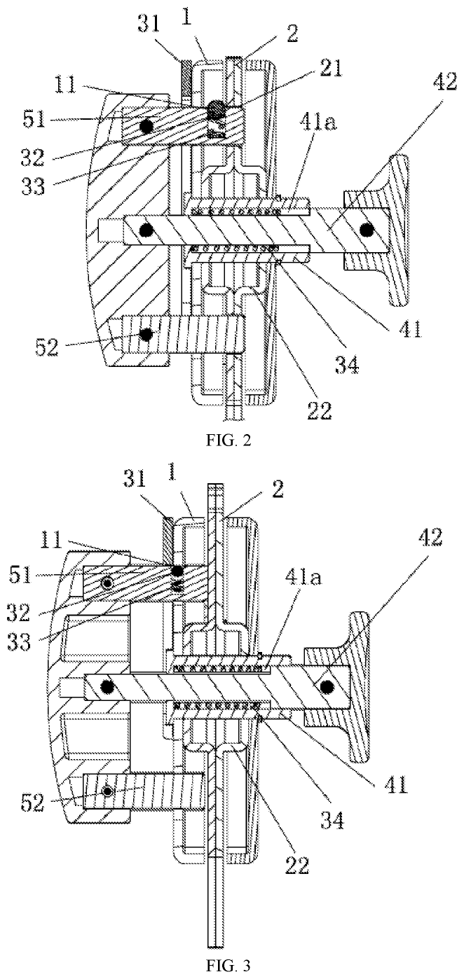

As shown in FIG. 1 to FIG. 3, this embodiment provides a rotation control mechanism for a folding ladder, comprising a first locking pin 51, and a first rotating member 1 and a second rotating member 2 which are rotatably connected. Wherein, the first rotating member 1 is provided with a pin hole 11, and the second rotating member 2 is provided with a locking hole 21. The first locking pin 51 is inserted into the pin hole 11 and the locking pin 21 to lock the first rotating member 1 and the second rotating member 2.

The first locking pin 51 and the first rotating member 1 are circumferentially limited and movably arranged in an axial direction, that is, the first locking pin 51 and the pin hole 11 are basically coaxial, so that the situation that the first locking pin 51 cannot be inserted into the pin hole 11 due to rotation of the first rotating member 1 and the second rotating member 2 is avoided; moreover, the rotation of the first locking pin 51 in the pin hole 11 is limited, so that a trigger portion 31 can push an elastic braking portion without being affected. Preferably, in this embodiment, the first locking pin 51 stretches into the pin hole 11, and when the first rotating member 1 and the second rotating member 2 are unlocked or locked, the first locking pin 51 moves in the pin hole 11 in the axial direction.

The first locking pin 51 is connected to a first elastic member 34. The first elastic member 34 applies an action force to the first locking pin 51 to be inserted into the locking hole 21.

The second rotating member 2 is provided with the trigger portion 31.

The first rotating member 1 is provided with the elastic braking portion, and preferably, the elastic braking portion extends along the first rotating member 1 in a radial direction.

When the first rotating member 1 and the second rotating member 2 are to be unlocked, an external force is applied to the first locking pin 51 to retreat from the locking hole 21, the elastic braking portion rebounds to abut against the first rotating member 1 after retreating from the pin hole 11, and the first rotating member 1 and the second rotating member 2 are allowed to rotate. When the first rotating member 1 and the second rotating member 2 rotate, the trigger portion 31 pushes the elastic braking portion to retreat elastically, so that the elastic braking portion is not hindered by the first rotating member 1 anymore. In this embodiment, the first elastic member 34 rebounds to drive the first locking pin 51 to move towards the second rotating member 2 until the first locking pin 51 abuts against the second rotating member 2. The first rotating member 1 and the second rotating member 2 continue to rotate, the first elastic member 34 rebounds to drive the first locking pin 51 to be inserted into the locking hole 21 after the first locking pin 51 is aligned with the locking hole 21, and at this moment, the first rotating member 1 and the second rotating member 2 are locked.

Wherein, in the unlocked state, the first locking pin 1 may be completely inserted into the lock hole 11 and may also partially or completely retreat from the pin hole 11. All these transformations made without affecting the rotation of the first rotating member 1 and the second rotating member 2 in the unlocking process should fall within the protection scope of the invention.

The moving distance of the first locking pin 51 may be controlled by lifting a handle on the same side, the handle pulls the first locking pin 51 to move away from the locking hole 21, the first elastic member 34 is stretched, and preferably, the first elastic member 34 is a tension spring. Specifically, in this embodiment, the rotation control mechanism for a folding ladder further comprises an operating member 42 and a center pin 41. The first rotating member 1 and the second rotating member 2 are rotatably connected through the center pin 41. The operating member 42 is fixed to the first locking pin 51 after penetrating through the center pin 51, and the operating member 42 is coaxial with the center pin 41. The operating member 42 pushes the first locking pin 51 to move away from the locking hole 21, and at this moment, the first elastic member 34 is compressed. Preferably, the first elastic member 34 is a spring. The center pin 41 is provided with a receiving cavity 41a, and the operating member 42 penetrates through the receiving cavity 41a. The spring is disposed around the operating member 41 and is received in the receiving cavity 41a.

In this embodiment, the trigger portion 31 is a plate. The plate has an arc surface that abuts against the elastic braking portion. That is, when the first rotating member 1 and the second rotating member 2 rotate, the arc surface is located in the moving path of the elastic braking portion, and the elastic braking portion is pressed by the arc surface to retreat to be not hindered by the first rotating member 1 anymore. Preferably, the plate is an arc plate. The plate may be fixed to the second rotating member 2 through a connecting part such as a fastener.

The trigger portion 31 may be a protruding rib on the second rotating member 2. The rib has an arc surface that abuts against the elastic braking portion. The rib and the second rotating member 2 are formed integrally.

A vacant site 31a is disposed at the unlocking position, so the elastic braking portion will not be compressed by the trigger portion 31 in the unlocking process, which may otherwise lead to a failure of the elastic braking portion to abut against the first rotating member 1.

Wherein, multiple locking holes 21 may be arranged, and the first locking hole 51 may be inserted into different locking holes 21 to lock the first rotating member 1 and the second rotating member 2 at different angles. In this embodiment, three locking holes 21 are arranged, and three vacant sites 31a where the elastic braking portion does not abut against the trigger portion 31 are disposed at positions corresponding to the three locking holes 21. Specifically, two arc surfaces are arranged, one vacant site 31a is located between the two arc surfaces, and the other two vacant sites 31a are located at two ends of the two arc surfaces. In this way, when the rotation control mechanism is used for a folding ladder.

With the rotation axis of the first rotating member 1 and the second rotating member 2 as an axis, an interval R′ is formed between the vacant sites 31a. The distance from the arc surface to the axis is greater than the distance from the first locking pin 51 to the axis, so that the first locking pin 51 can rotate with respect to the trigger portion 31; and the distance from the arc surface to the axis is smaller than the distance from the elastic braking portion to the axis, so that the trigger portion 31 can push the elastic braking portion to be compressed, and under the action of an elastic force from the first elastic member 34, the first locking pin 51 moves to abut against the second rotating member 2. In addition, a sufficient space is reserved at the vacant site 31a to allow the elastic braking portion to move, so that at the unlocking position, the elastic braking portion can rebound at the vacant site 31a to abut against the first rotating member 1.

The elastic braking portion comprises a second elastic member 33 and an engaging element 32. The second elastic member 33 abuts against the engaging element 32 and is maintained in the first locking pin 51. The second elastic member 33 may be an elastic element or a spring. The elastic element or spring applies an elastic force to the engaging element 33. Preferably, an arc surface is formed at the end of the engaging element 33. Preferably, the arc surface is a spherical surface. The spherical surface of the engaging element 33 can realize smooth transition when abutting against the first rotating member 1 or the trigger portion 31. In this embodiment, the second elastic member 33 is a spring, and the engaging element 33 is a steel ball. The first locking pin 51 has a receiving cavity formed with an opening, the steel ball is received in the receiving cavity, and the spring is located between an inner wall of the receiving cavity and the steel ball, and the opening of the receiving cavity is smaller than the diameter of the steel ball, so that the spring and the steel ball are both maintained in the first locking pin 51.

Preferably, the rotation control mechanism for a folding ladder further comprises a second locking pin 52. The second locking pin 52 and the first locking pin 51 are distributed symmetrically with respect to a hinge center of the first rotating member 1 and the second rotating member 2. When the first locking pin 51 enters the pin hole 11 and the locking hole 21, the second locking pin 52 is inserted into the first rotating member 1 and the second rotating member 2. When the first locking pin 51 retreats from the locking hole 21, the second locking pin 52 retreats from the second rotating member 2. The second locking pin 52 and the first locking pin 51 are distributed symmetrically, so that the first rotating member 1 and the second rotating member can be fixed more stably, and the safety of a folding ladder is improved.

The first rotating member 1 comprises a first outer plate 12 and a second outer plate 13, and the second rotating member 2 is disposed between the first outer plate 12 and the second outer plate 13. The first outer plate 12 and the second outer plate 13 are fixedly connected. The first rotating member 1 is provided with multiple plates and/or the second rotating member 2 is provided with multiple plates, so that the strength of the rotation control mechanism for a folding ladder is improved.

A flange facing the second outer plate 13 is formed on the first outer plate 12, or a flange 14 facing the first outer plate 12 is formed on the second outer plate 13. In this embodiment, opposite flanges 14 are formed on the first outer plate 12 and the second outer plate 13, and the flanges 14 cover the second rotating member 2, that is, the flanges 14 cover a gap between the first rotating member 1 and the second rotating member 2, so that impurities are prevented from falling into the gap.

A projection 22 facing the first outer plate 12 is formed on the second rotating member 2, or a projection 22 facing the second outer plate 12 is formed on the second rotating member 2. In this embodiment, the projection 22 facing the first outer plate 12 is formed on the second rotating member 2, and the projection 22 facing the second outer plate 13 is also formed on the second rotating member 2. Through the projections 22, the integrity of the structure is improved, gaskets are not needed, and the situation that small parts such as gaskets are lost or missed is avoided.

Specifically, in this embodiment, when users want to unfold a folding ladder for use, the folding ladder in the folded state is unlocked first, the operating member 42 is pushed to compress the first elastic member 34, the first locking pin 51 is stressed to retreat from the first locking hole 21, at this moment, the elastic braking portion corresponds to the vacant site 31a at the end of one arc surface, and the elastic braking portion rebounds after retreating from the pin hole 11. The operating member 42 is released, the first elastic member 34 drives the first locking pin 51 to rebound until the elastic braking portion abuts against the first rotating member 1. When the first rotating member 1 and the second rotating member 2 are rotated to form a V shape, the trigger portion 31 pushes the elastic braking portion to retreat elastically, at this moment, the elastic braking portion is not hindered by the first rotating member 1 anymore, and the first elastic member 34 rebounds to drive the first locking pin 51 to move towards the second rotating member 2 until the first locking pin 51 abuts against the second rotating member 2. The first rotating member 1 and the second rotating member 2 continue to rotate, and when the first locking pin 51 corresponds to the locking hole 21 in position after the first rotating member 1 and the second rotating member 2 are unfolded to be in a linear shape, the first elastic member 34 drives the first locking pin 51 to be inserted into the locking hole 21, the first rotating member 1 and the second rotating member 2 are locked, and the elastic braking portion corresponds to the vacant site 31a between the two arc surfaces for later unlocking; and at this moment, the folding ladder is in a V shape for use. The folding ladder can be switched to the linear shape along the original rotation track after being unlocked. When the first rotating member 1 and the second rotating member 2 are to be unlocked in the linear state, the vacant site 31a at the end of the arc surface pushes the operating member 42 to enable the elastic braking portion to abut against the first rotating member 1, and then, the first rotating member 1 and the second rotating member 2 can rotate reversely along the original rotation track.

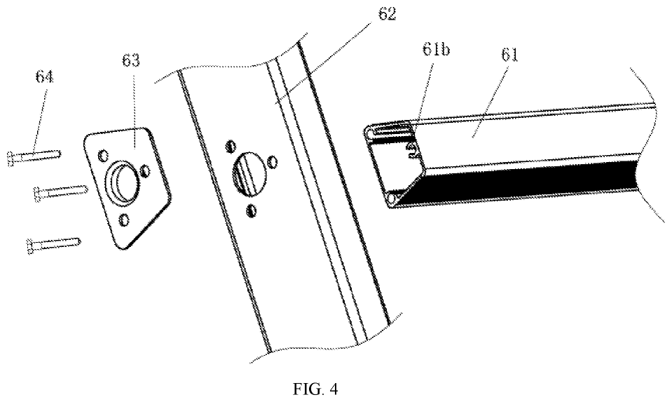

As shown in FIG. 1 to FIG. 4, a folding ladder in this embodiment comprises two ladders and two rotation control mechanisms for a folding ladder. A top of one ladder is connected to the first rotating member 1, and a top end of the other ladder is connected to the second rotating member 2. The two ladders can be folded or form a V shape or a linear shape to be suitable for different occasions by rotating and fixing the first rotating member 1 and the second rotating member 2.

Each ladder comprises steps 61 and two ladder legs 62, wherein two ends of each step 61 are connected to the ladder legs 62. The steps 61 are hollow isosceles trapezoidal profiles. When the folding ladder is in a folded state, one side face 61a of each step 61 is a step face; and when the folding ladder is in an unfolded state, the other side face 61a of each step 61 may be used as a step face. These transformations may be realized easily through the isosceles trapezoidal steps.

The two side faces 61a of each step 61 are concave-convex faces, so that the friction of the side faces 61a is improved, and users may step on the steps 61 more safely.

Three axial holes 61b are formed in an inner surface of each step 61 and are located in the middle of an inner side of the top and two corners of the bottom of the step 61 respectively.

The folding ladder further comprises gaskets 63. Screws 64 penetrate through the gaskets 63, the ladder legs 62 and the axial holes 61b sequentially to connect the ladder legs 62 and the steps 61.

The embodiments described above in the specification are merely illustrative examples of the invention. Various amendments or supplements or similar substitutions made to the above specific embodiments by those skilled in the art without departing from the contents in the specification of the invention or exceeding the scope defined by the claims of the invention should also fall within the protection scope of the invention.

What is claimed is:

1. A rotation control mechanism for a folding ladder, comprising a first rotating member, a second rotating member and a first locking pin, wherein
the first rotating member is provided with a pin hole, the second rotating member is provided with a locking hole, the first locking pin is inserted into the pin hole and the locking hole to lock the first rotating member and the second rotating member, wherein:
the first locking pin and the first rotating member are circumferentially limited and movably arranged in an axial direction;
the first elastic member is connected to the first locking pin and applies an action force to the first locking pin to be inserted into the locking hole;
the second rotating member is provided with a trigger portion;
the first rotating member is provided with an elastic braking portion;
an external force is applied to the first locking pin to retreat from the locking hole, the elastic braking portion abuts against the first rotating member, and the first rotating member and the second rotating member are allowed to rotate;
when the first rotating member and the second rotating member rotate, the trigger portion pushes the elastic braking portion to retreat elastically, the elastic braking portion is no longer hindered by the first rotating member, and the first locking pin is aligned with the locking hole and is then inserted into the locking hole.

2. The rotation control mechanism according to claim 1, further comprising an operating member and a center pin, wherein the first rotating member and the second rotating member are rotatably connected through the center pin; the operating member is fixed to the first locking pin after penetrating through the center pin, and the operating member is coaxial with the center pin; and the operating member pushes the first locking pin to move away from the locking hole.

3. The rotation control mechanism according to claim 2, wherein the first elastic member is a spring; the center pin is provided with a receiving cavity, and the operating member penetrates through the receiving cavity; and the spring is disposed around the operating member and is received in the receiving cavity.

4. The rotation control mechanism according to claim 1, wherein the elastic braking portion comprises a second elastic member and an engaging element, and the second elastic member abuts against the engaging element and is maintained in the first locking pin.

5. The rotation control mechanism according to claim 1, wherein the trigger portion is a plate, and the plate has an arc surface, wherein the arc surface abuts against with the elastic braking portion.

6. The rotation control mechanism according to claim 1, wherein the trigger portion is a protruding rib on the second rotating member, and the rib has an arc surface, wherein the arc surface abuts against the elastic braking portion.

7. The rotation control mechanism according to claim 5, wherein three locking holes are arranged, and three vacant sites where the elastic braking portion does not abut against the trigger portion are disposed at positions corresponding to the three locking holes.

8. The rotation control mechanism according to claim 7, wherein two surfaces are arranged, and the three vacant sites are located between the two arc surfaces; and/or, the three vacant sites are located at ends of the two arc surfaces.

9. The rotation control mechanism according to claim 1, further comprising a second locking pin, wherein the second locking pin and the first locking pin are distributed symmetrically with respect to a rotation axis of the first rotating member and the second rotating member; when the first locking pin enters the pin hole and the locking hole, the second locking pin is inserted into the first rotating member and the second rotating member; and when the first locking pin retreats from the locking hole, the second locking pin retreats from the second rotating member.

10. The rotation control mechanism according to claim 1, wherein the first rotating member comprises a first outer plate and a second outer plate, the second rotating member is disposed between the first outer plate and the second outer plate, and the first outer plate and the second outer plate are fixedly connected.

11. The rotation control mechanism according to claim 10, wherein a flange facing the second outer plate is formed on the first outer plate, and/or a flange facing the first outer plate is formed on the second outer plate; and the flange covers the second rotating member.

12. The rotation control mechanism according to claim 10, wherein a projection facing the first outer plate is formed on the second rotating member, and/or a projection facing the second outer plate is formed on the second rotating member.

13. A folding ladder, comprising two ladders, and two rotation control mechanisms according to claim 1, wherein the two ladders are a first ladder and a second ladder, a top of the first ladder is connected to the first rotating member, and a top end of the other the second ladder is connected to the second rotating member.

14. The folding ladder according to claim 13, wherein each of the two ladders comprises steps and two ladder legs, two ends of each of the steps are connected to the two ladder legs, and the steps are hollow isosceles trapezoid profiles.

15. The folding ladder according to claim 14, wherein two side faces of each of the steps are concave-convex faces.

16. The folding ladder according to claim 14, wherein three axial holes are formed in an inner surface of each of the steps and are located in a middle of an inner side of a top and two corners of a bottom of each of the steps respectively.

17. The folding ladder according to claim 16, wherein each of the two ladders further comprises gaskets, and screws penetrate through the gaskets, the two ladder legs and the three axial holes sequentially to connect the two ladder legs and the steps.

18. The rotation control mechanism according to claim 2, wherein the elastic braking portion comprises a second elastic member and an engaging element, and the second elastic member abuts against the engaging element and is maintained in the first locking pin.

19. The rotation control mechanism according to claim 6, wherein three said locking holes are arranged, and three vacant sites where the elastic braking portion does not abut against the trigger portion are disposed at positions corresponding to the three locking holes.

20. The rotation control mechanism according to claim 2, further comprising a second locking pin, wherein the second locking pin and the first locking pin are distributed symmetrically with respect to a rotation axis of the first rotating member and the second rotating member; when the first locking pin enters the pin hole and the locking hole, the second locking pin is inserted into the first rotating member and the second rotating member; and when the first locking pin retreats from the locking hole, the second locking pin retreats from the second rotating member.
